(19) United States
(12) Patent Application Publication
(10) Pub. No.: US 2025/0379736 A1
(43) Pub. Date: Dec. 11, 2025

(54) ENCRYPTION WITH INFINITE LATTICE CRYPTOGRAPHY

(71) Applicant: Applied Physics, Inc., New York, NY (US)

(72) Inventors: Gianni Martire, New York, NY (US); Haydn Kirk Vestal, Austin, TX (US)

(21) Appl. No.: 19/212,542

(22) Filed: May 19, 2025

Related U.S. Application Data
(60) Provisional application No. 63/649,096, filed on May 17, 2024.
(60) Provisional application No. 63/703,288, filed on Oct. 4, 2024.
(60) Provisional application No. 63/741,391, filed on Jan. 2, 2025.

(51) Int. Cl. H04L 9/30

(52) U.S. Cl. CPC H04L 9/3093

(57) ABSTRACT

An infinite lattice encryption (ILC) can include encrypting an entire, as opposed to individual, or bit-by-bit, encryption of the elements in the field. String data can be converted to high-entropy quantitative data, for example, a two-dimensional vector and encrypted using the described encryption algorithm. The conversion can preserve the collation order of the string if one dimension of the quantitative data is from a sorted set of random numbers. Executables, such as computer programs, can be encrypted using ILC. The computer program can be turned into a graph of operations, where each edge can be replaced, based on a number randomly chosen from an encryption co-domain. The numerical and string data in the graph can be encrypted using the described ILC techniques.

### CROSS-REFERENCE TO RELATED APPLICATIONS

This application claims the benefit of priority of U.S. Provisional Application No. 63/741,391, filed on Jan. 2, 2025, entitled, “EXECUTABLE ENCRYPTION WITH INFINITE LATTICE CRYPTOGRAPHY,” U.S. Provisional Application No. 63/703,288, filed on Oct. 4, 2024, entitled, “INFINITE LATTICE STRING CRYPTOGRAPHY,” and U.S. Provisional Application No. 63/649,096, filed on May 17, 2024, entitled, “INFINITE LATTICE CRYPTOGRAPHY,” the contents of which are hereby incorporated in their entirety and should be considered a part of this application.

### BACKGROUND

### Field

This invention relates generally to the field of computer cryptography, and more particularly to systems and methods of lattice cryptography.

### Description of the Related Art

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Fully homomorphic cryptosystems have been proposed but are not in widespread use due to major performance and accuracy drawbacks. An example of a popular fully homomorphic encryption (FHE) cryptosystem is Torus fully homomorphic encryption (TFHE), due to its relatively high performance, but it only supports bit-wise logic gates and remains vastly slower than equivalent computations on plaintext. Furthermore, existing homomorphic encryption schemes accumulate errors with each operation on ciphertext, although some limited mitigation procedures for this exist, they have not proven adequate for addressing the issue of error accumulation in this technology area.

For these and similar reasons, existing encryption schemes, particularly in the area of homomorphic encryption, have seen limited use due to low performance and incompatibility with hardware accelerators. Therefore, robust encryption systems and methods, including those used in homomorphic encryption and computing, can be beneficial to various industries.

### SUMMARY

The appended claims may serve as a summary of this application. Further areas of applicability of the present disclosure will become apparent from the detailed description, the claims, and the drawings. The detailed description and specific examples are intended for illustration only and are not intended to limit the scope of the disclosure.

### BRIEF DESCRIPTION OF THE DRAWINGS

These drawings and the associated description herein are provided to illustrate specific embodiments of the invention and are not intended to be limiting.

FIG. 1 illustrates a diagram of a type of homomorphic encryption, where individual encryption of elements or points is used.

FIG. 2 illustrates a diagram of an embodiment, where field encryption is used.

FIG. 3 illustrates a block diagram of a homomorphic encryption algorithm, according to an embodiment.

FIG. 4 illustrates a flowchart of an example method of an infinite lattice encryption, according to an embodiment.

FIG. 5 illustrates a block diagram of generating a high entropy quantitative data structure from a string.

FIG. 6 illustrates a flowchart of a method for high-entropy conversion of a string to quantitative data.

FIG. 7 illustrates a flowchart of a method for encrypting vectors, using a quantitative encryption algorithm.

FIG. 8 illustrates a block diagram of an example decryption technique for decrypting a string, according to an embodiment.

FIG. 9 illustrates a flowchart of a decryption algorithm for decrypting a string encrypted using the embodiments of FIGS. 6 and 7.

FIG. 10 illustrates an environment in which some embodiments may operate.

FIG. 11 illustrates an environment 1100 of generating and distributing an encrypted computer program, according to an embodiment.

FIG. 12 illustrates diagrams 1200 of graphs that are generated from a computer program, as intermediary steps for generating an encrypted program.

FIG. 13 illustrates diagrams 1300 of example operations that can be performed in some embodiments of executable encryption.

FIG. 14 includes a method 1400 of executable encryption, according to an embodiment.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements. Some of the embodiments or their aspects are illustrated in the drawings.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

Homomorphic computing and homomorphic cryptography, assuming a practical implementation, can present attractive technologies for modern computing. Homomorphic encryption gives an organization the ability to have an outside organization perform mathematical operations on its encrypted data, without exposing the unencrypted data to the outside organization. In the modern computing landscape, the input data can be sensitive or regulated. Often the expertise to process sensitive data, build artificial intelligence models, and otherwise utilize the data, may reside in an outside organization, or a third-party. In these scenarios, one organization is in possession of the sensitive or regulated input data, and another organization is in possession of the skills and experience to utilize the data and build tools, based on the data. For example, hospitals and banks are in possession of sensitive, regulated, or confidential data, while outside engineering firms have the skill and the experience to build machine learning models and/or other new tools for the hospitals, banks, or other organizations, to process the stored sensitive data. Existing homomorphic encryption and computing tools can be slow and inefficient, preventing or reducing the rate of their widespread adoption. As a result, there is a need for robust homomorphic encryption and homomorphic computing, where an organization can provide its sensitive data to an outside vendor, in an encrypted form, to obtain analysis, models, tools, or applications, built based on the sensitive data, without exposing the unencrypted data to the outside vendors.

The described embodiments include infinite lattice encryption systems and methods that can be used to implement zero-knowledge proofs, a cryptographic tool used to verifiably interrogate secret data without revealing the data to the verifier. Some popular zero-knowledge proof schemes are zero-knowledge succinct non-interactive argument of knowledge (zk-SNARKs), zero-knowledge Scalable Transparent Argument of Knowledge (zk-STARKS), and Bulletproofs, which are limited in functionality to proving the relative order of a number, or whether an item is present in a set. Infinite lattice encryption, as described herein, may be used to compose more general zero-knowledge proofs by projecting both the prover's ciphertext and the verifier's plaintext into a common codomain, within some statistical limits on the distribution of encrypted data and the protocol by which this shared projection is constructed. This is a form of pairing-based encryption which can be extended to an arbitrary sequence of untrusted parties in a distributed system simply by generating new pairings. Consequently, robust infinite lattice encryption, as described herein, can have substantial applicability in the area of zero-knowledge proofs and related technologies.

An example encryption algorithm works by generating a polynomial from an input number. The polynomial is related to the input number by some mathematical function that is difficult to reverse. The difficult-to-reverse results are provided to a public space, where the public space in this context refers to an entity that is intended to not have access to the unencrypted input number. The process of encryption can be applied to a database. The database can have millions of rows of numbers, where encrypting each number in the database, correspondingly, generates millions of polynomials. In this and similar homomorphic encryption schemes, a public processor works with millions of polynomials (or other complex encrypted data), which can have several disadvantages. Performing mathematical calculations on polynomials, or other complex encrypted data structures, are computationally more expensive than performing the same calculations on unencrypted numbers. Unlike when working with unencrypted numbers, the public processor, (e.g., a machine learning model builder), cannot easily run the calculations on parallel processors, such as hardware accelerators. Such accelerators work by applying the same algorithm (e.g., multiplication) to the same input data (e.g., numbers). In the case of encrypted polynomials, parallel processors cannot easily apply the same algorithm to them because, unlike operations on unencrypted numbers, operations on polynomials require different algorithms.

Another challenge with existing homomorphic encryption schemes is the accumulation of noise or error. As part of applying the encryption algorithm, many of such algorithms, may introduce noise, by design to increase the resilience of the encryption, or error, as an incidental side-effect of the algorithm. In these scenarios, performing operations on encrypted data, with built-in noise, or error, can lead to noise or error accumulation. The more operations one performs on encrypted data, with built-in noise or error, the more the results can accumulate noise or error.

In some homomorphic encryption techniques, numbers in a field are encrypted individually. In some methods, bit-by-bit encryption is used. Individual encryption can create the challenges described above, such as performance inefficiencies, lack of hardware acceleration compatibility, due to having to operate on polynomials and accumulation of noise or error. In some embodiments, the field or space, instead of the individual numbers in the field or space, can be encrypted. For example, a metric that can project a number into a field or space can be encrypted, thereby encrypting the field or space. Within the encrypted field, operations can be performed in parallel because the operations can be performed on the same input data in the encrypted field. Furthermore, the operations can be performed efficiently, since the elements in the encrypted field, relative to the operations within the field are not of mismatched character or complexity. The space or field, in this context, can be a set of elements, for example, points, vectors, or other data structures with a notion of distance between those elements. The distance is measured by a metric function or distance function. For example, in a one-dimensional number space, the metric function defining the space is the number “1.” In two- or three-dimensional Euclidean space, the metric functions defining the two- or three-dimensional spaces are the norm functions, where the norm functions define the distance to an origin.

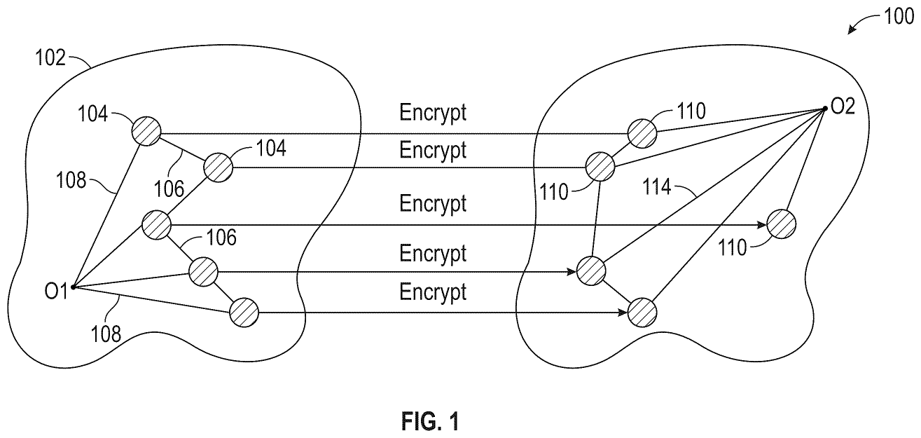

FIG. 1 illustrates a diagram 100 of a type of homomorphic encryption, where individual encryption of elements or points is used. For example, bit-wise encryption may be used. Points 104 can be bits or individual elements of an input dataset 102. As an example, the input dataset 102 may be a collection of numbers from a database. For ease of illustration only a few points 104 are shown. In practice, the point 104 can be millions or higher in quantity. In several modern computing applications, the points 104 can represent regulated, sensitive, or otherwise confidential data, whose custodian is charged with its secure maintenance. In one application, the custodian of the input dataset 102 may wish to provide an encrypted version of the input dataset 102 to a vendor, to be used as machine learning training data, so the vendor can build and train machine learning models for the use of the custodian or for other purposes. In other words, the custodian of the input dataset 102 wishes the vendor to perform homomorphic computing on the input dataset 102 to obtain results. The custodian performs homomorphic encryption to generate an encrypted version of the input dataset 102 and provides the encrypted version to the vendor. The vendor performs homomorphic computation, not having visibility into the unencrypted data, and provides the results back to the custodian. The custodian can receive and decrypt the results, even when the result data were not present in the original plaintext. In homomorphic encryption and computation, the results are identical or near identical, had the computation been performed on unencrypted data.

The input dataset 102 can be an input to an encryption system, for example, one that uses polynomials for encryption. The points 104 have a relative distance 106 to one another and a distance 108 to an origin O1. In individual encryption, each point 104 is encrypted individually, generating an encrypted point 110. The encrypted points 110 can each be a different polynomial, generated based on the polynomial used in the encryption technique. In individual encryption, the encrypted points 110 do not maintain the same relative distance to one another or to the origin, relative to their pre-encryption distances 106, 108. Furthermore, performing operations on the encrypted points 110 can be inefficient. The points 104 can be relatively less complex (e.g., they can be real numbers), while the encrypted points 110 are polynomials. Therefore, performing operations on the encrypted points 110 can be more computationally expensive and inefficient, compared to those performed on points 104. Furthermore, the encrypted points 110, being polynomials, are not suitable candidates for processing in a hardware accelerator. Since building machine learning models, in many cases, take advantage of hardware accelerators, the incompatibility of individual encryption with such devices, severely limits the application of homomorphic computing in the area of artificial intelligence and machine learning. For example, some lattice encryption schemes typically encipher data onto a finite field (a lattice of discrete points), rendering the result unusable for machine learning applications since the backpropagation algorithm used to train machine learning models depends on the assumption that its parameters lie on a continuously differentiable field (an infinite lattice).

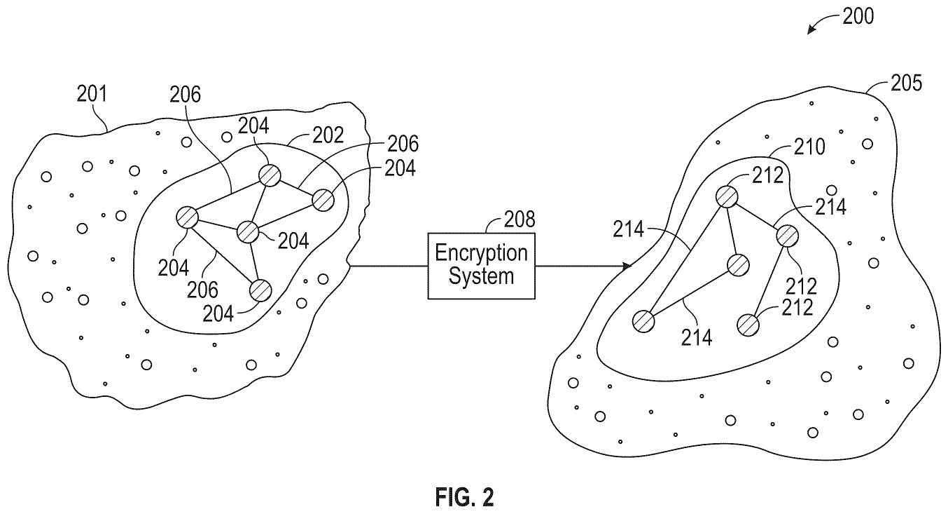

FIG. 2 illustrates a diagram 200 of an embodiment, where field encryption is used. The input dataset 202 can include points 204. The input dataset 202 can be a low dimensional space, for example, one-dimensional numbers, two-dimensional vectors, or three-dimensional vectors, depending on the underlying data. As an example, if the input dataset 202 is medical data, collected for medical research, and to train machine learning models for processing medical data, the points 204 can be real numbers. Examples include results of a selection of medical tests, probability numbers, or other numerical representation of medical data. In other application areas, for example, in financial applications, the points 204 can represent different classes of data. The points 204 reside in and belong to an input field or space 201. The input field 201 can be defined as a set of elements or points, together with a notion of distance between the elements. The distance is measured or defined by a metric function. For example, if the points 204 are one-dimensional numbers, the metric function defining the input field 201 can be the number “1.” If the points 204 are two-dimensional vectors, the metric function defining the input field 201 is the norm of the Cartesian plane, or the distance to an origin.

An encryption system 208, according to some embodiments, can encrypt the field 201 into an encrypted field 205. The encryption system 208 can encrypt a field-defining characteristic, such as the metric of the field, instead of encrypting each individual elements of the field. In this manner, projection of any points, using the encrypted metric, would generate an encrypted point 212, by virtue of the projected point having been projected into an encrypted field. The entire input dataset 202 can be projected into the encrypted field 205, generating the encrypted dataset 210. Since the encrypted points 212 are projections obtained by using the same encrypted metric, the relative distance 214 between the encrypted points 212, maintain the relative distances 206 in the unencrypted input dataset 202. Maintaining relative distance, compared to the unencrypted input dataset, can enable more useful homomorphic computations. In terms of robust and practical encryption applications, the encrypted field 205 is usually constructed to be of higher dimensions, compared to the input field 201. Furthermore, the described field encryption is computationally less demanding, compared to individual encryption, as the expensive encryption step is performed only once, in relation to the metric of the field, and not repeated again, when projecting individual elements into the encrypted field 205.

Some cryptosystems, such as THE encrypt a plaintext of n individual data to produce a ciphertext of n individual polynomials. The described embodiments can provide encryption by encrypting only the Euclidean metric of the field on which a set of plaintext data lie to produce a Riemannian metric, which defines a notion of distance in a ciphertext space, such that the encrypted metric admits a consistent definition of the operations within the field. Operations, such as addition, multiplication, and ordering. In other words, the encrypted metric serves as a homomorphic hash function. The noise introduced by the encryption is encoded in the extra dimensions, meaning the plaintext data is encoded as mutual information in a (typically higher-dimensional) Riemannian vector space. This does not constitute key reuse because the key is used only once-to encrypt the geometry itself.

### Example Encryption Algorithms

In some embodiments, the encryption algorithm can include the following steps. Step “1” includes gathering the plaintext dataset Rₚₗₐᵢₙ. Step “2” includes choosing a radial basis kernel RBₚₗₐᵢₙ. Step “3” includes constructing an unencrypted projection RB(Rₚₗₐᵢₙ). Step “4” includes choosing a polynomial and encrypting the RBₚₗₐᵢₙ to produce a polynomial RB_{cipher}, which functions as the metric of R_{cipher}. Step “5” includes, using the mapping RBₚₗₐᵢₙ→RB_{cipher} to construct the ciphertext dataset R_{cipher}. Step “6” includes building the operators of the encrypted field, R_{cipher}, for example, constructing an addition operator, add_{cipher} and a multiplier operator, mul_{cipher}, based on RB_{cipher}. In some embodiments, step “6” can be performed by a vendor, who does not have visibility into the unencrypted plaintext dataset, Rₚₗₐᵢₙ.

At each step, the notion of relative magnitude (or distance between points or elements in the field) is preserved, enabling a universal ordering defined by a norm |x| where x∈R_{cipher}, without any unique inverse |x|→x∈R_{cipher}, which is the homomorphic property of the described algorithm. Noise may be introduced into the metric by the encryption performed in step “4”, while the mapping in step “5,” preserves the noise in R_{cipher}. This can make any x∈R_{cipher} computationally hard to decrypt. In other words, the encrypted data, R_{cipher} do not reveal any information which reduces the computational complexity of decrypting RB_{cipher}. The implementor of the described algorithm can choose any encryption algorithm which generates a polynomial RB_{cipher} from a linear function expressed as a matrix RBₚₗₐᵢₙ (also, optionally with other configuration of data such as a key and a nonce). In practice, the encryption performed in step “4” is preferably a lattice-based cryptosystem such as number theory research unit (NTRU) encryption, ring learning with errors, or other robust encryption algorithms, now known, or later developed, where such algorithms have resistance to attacks enabled by quantum computers. While using a robust encryption algorithm in step “4” increases the resilience of the encryption system, this is not a mathematical requirement of the described encryption system.

### Encrypted Operators or Ciphertext Operators

The identities |x₀|=0, |x|+|x|=|x+x| ∀ R_{cipher}, and |x|*|x|=|x*x| ∀ R_{cipher} form a system of equations which can be solved to recover values for the linear operators “+” and “*,” among others, on the field R_{cipher}. Since the metric RB_{cipher} can be a linear function, the field R_{cipher} is smoothly differentiable at all points x∈R_{cipher}. This system of equations can effectively function as a checksum to verify the integrity of the data x∈R_{cipher}.

The negation operator, “−,” is a unary symmetric reflection vector defined by RB_{cipher}, such that for x₂≡−x₁, −x₂=x₁ and |x|=|−x|. The negation operator can be constructed using the identities x₀=−x₀ and |x|=|−x| ∀ R_{cipher}, where x₀ is a unique vector such that |x₀|=0.

The reciprocal operator “\hat{ }(−1)” is a unary symmetric scaling vector defined by RB_{cipher}, such that for x₂≡x₁\hat{ }(−1), |x₂|=|x₁|\hat{ }(−1). The reciprocal operator can be constructed using the identity |x\hat{ }(−1)|=|x|\hat{ }(−1) ∀ R_{cipher}.

The addition operator “+” is a symmetric translation matrix defined by RB_{cipher}, such that for x₃=x₁+x₂, x₂+x₁=x₃ and |x₃|=|x₁|+|x₂|. The addition operator can be constructed using the identities x+x₀=x ∀ R_{cipher} and x+ (−x)=x₀ ∀ R_{cipher}, where the additive identity x₀ is a unique vector such that |x₀|=0.

The multiplication operator ‘*’ is a symmetric scaling matrix defined by RB_{cipher}, such that for x₃≡x₁*x₂, x₂*x₁=x₃ and |x₃|=|x₁|*|x₂|. The multiplication operator can be constructed using the identities x*x₀=x₀ ∀ R_{cipher} and |x*x\hat{ }(−1)|=1 ∀ R_{cipher}.

### Example Decryption Algorithm

A custodian of sensitive data can encrypt the data with an encryption algorithm described herein and provide the data to a vendor or processor. The processor can perform homomorphic computation on the encrypted data, generating encrypted results in the R_{cipher}. The vendor or processor can provide the encrypted results back to the custodian of data. The custodian of data can perform a decryption algorithm described herein to obtain the unencrypted results. The unencrypted results are the same as, or nearly the same as, if the vendor or processor had been provided with unencrypted data and performed computation on unencrypted data.

In some embodiments, the decryption algorithm includes the following steps. Step “1” includes gathering the encrypted result dataset R_{cipher}. Step “2” includes using the mapping RB_{cipher}→RBₚₗₐᵢₙ to construct the plaintext projection RBₚₗₐᵢₙ (Rₚₗₐᵢₙ). Step “3” includes using the Euclidean metric, or the radial basis kernel, on RBₚₗₐᵢₙ (Rₚₗₐᵢₙ) as a pullback function to reduce RBₚₗₐᵢₙ (Rₚₗₐᵢₙ) to Rₚₗₐᵢₙ.

In some embodiments, the decryption procedure does not strictly depend on any encryption key used to generate the metric of the ciphertext. RBₚₗₐᵢₙ can serve as the decryption key, but the average case complexity of determining RBₚₗₐᵢₙ from RB_{cipher} remains difficult, provided a robust encryption algorithm is chosen to generate RB_{cipher}.

In some embodiments, the “R” in Rₚₗₐᵢₙ and R_{cipher} refers to the set of all real numbers, as a notation for describing a vector field. Vectors in Rₚₗₐᵢₙ describe points in the Riemannian space RBₚₗₐᵢₙ(Rₚₗₐᵢₙ) before infinite lattice encryption, and vectors in R_{cipher} describe points in the Riemannian space R_{cipher}=RB_{cipher} (RBₚₗₐᵢₙ (Rₚₗₐᵢₙ)), which is the result of the infinite lattice encryption procedure described herein.

In some embodiments, RBₚₗₐᵢₙ and RB_{cipher} refer to Radial Basis kernel functions. In some implementations of the described geometric encryption, both a polynomial and a Euclidean radial basis kernel are used to construct the RBₚₗₐᵢₙ because only a small standard set of possible radial basis kernels are known to project a 1-dimensional input into N-dimensions, while preserving order and magnitude. A Euclidean radial basis kernel may be used in addition to an encrypted polynomial to construct RB_{cipher}, but this is not strictly necessary because RB_{cipher} does not change the dimensionality “N” of an input vector. In other words, the RBₚₗₐᵢₙ and RB_{cipher} function as two different Riemannian metrics. In a robust application of the described technology, a non-trivial choice of RBₚₗₐᵢₙ can increase the resilience and security of the described encryption. Two projections into two Riemannian spaces are used (one into the plaintext Riemannian and one into the ciphertext Riemannian space). The non-trivial choice of RBₚₗₐᵢₙ and two projections into higher dimensions reduce the possibility of an external party being able to “guess” the private key. For example, without the described steps, if the custodian of data chooses a trivial metric for Rₚₗₐᵢₙ (e.g., RBₚₗₐᵢₙ=1, the one-dimensional Euclidean metric of the number line) and sends the data in R_{cipher} to an external entity, the external entity may be able to derive the “private key,” used by the custodian in the infinite lattice encryption procedure.

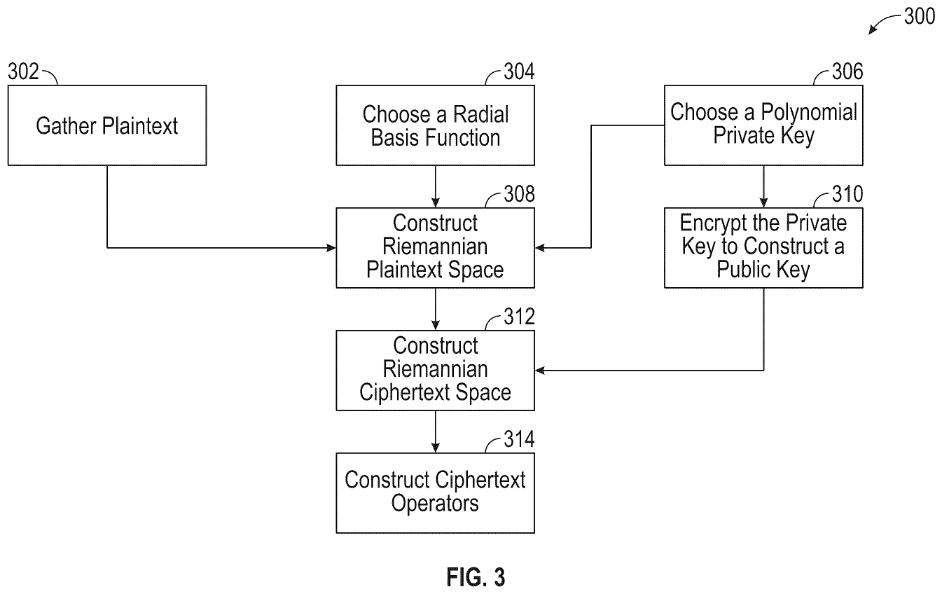

FIG. 3 illustrates a block diagram 300 of a homomorphic encryption algorithm, according to an embodiment. Block 302, gathers a plaintext dataset. Plaintext in this context refers to unencrypted data, pending input into the described cryptographic systems and/or algorithms, and not necessarily text or string data as may be understood in other computer science fields. Block 304 chooses a radial basis function. The radial basis function is used in projecting the plaintext dataset to a Riemannian plaintext space, where the dimensionality of the plaintext dataset is increased. For example, a 1-dimensional plaintext dataset is projected into a 6 or 7 dimensional plaintext space. Block 306 chooses polynomial as a private key. Both the polynomial and the radial basis function are used in block 308, where a Riemannian plaintext space is constructed by projecting the plaintext dataset into a higher dimension space. In one implementation, the product of the radial basis function and the selected polynomial is used to construct a radial basis function, used in the projection. The radial basis function and the projection in block 308, when constructing the Riemannian plaintext space, preserve the relative order and magnitude of the elements in the plaintext dataset in the projected spaces.

Block 310 encrypts the private key, generating a public key. Block 312 generates a Riemannian ciphertext space, from the Riemannian plaintext space of block 308, with the encrypted private key of block 310, used as the Riemannian metric for constructing the ciphertext space. In some embodiments, the ciphertext space can be a Hilbert space. In other words, the transformation described in relation to the described encryption algorithms can include transformation that take finite-dimensional Euclidean vector space data to an infinite-dimensional Hilbert space.

In some embodiments choosing a polynomial, at block 306, include selecting a positive integer of degree “N,” or the dimensionality of the ciphertext space R_{cipher}. This choice can be application-dependent. A higher “N” can result in greater security at the cost of lower performance. Various factors may be considered in the selection of the polynomial. Example factors include the entropy of the plaintext data, prior knowledge and computing power of a hypothetical adversary, the cost of the data being compromised, and other factors. Furthermore, choosing the polynomial private key can include selecting “N” random coefficients and “N” random exponents.

In some embodiments, choosing a radial basis function (RBF), at block 304 can include selecting a Euclidean radial basis function (e.g., Gaussian, linear, cubic, quintic, multiquadric, etc.), and generating its product with the polynomial private key to construct a Riemannian radial basis kernel RBₚₗₐᵢₙ. RBₚₗₐᵢₙ can serve as a metric on the unencrypted Riemannian vector space RBₚₗₐᵢₙ (Rₚₗₐᵢₙ). The specific choice of RBF can depend on the design preferences of the implementer of the described systems and methods. For example, the choice of RBF can depend on a selected numerical stability of the implementation, the convenience of supporting the specific number of dimensions “N,” whether the implementation is provided in or by a popular development framework, such as SciPy, TensorFlow, PyTorch, and other implementation preferences.

In some embodiments, encrypting the private key to construct a public key at block 310 can include utilizing a robust encryption algorithm, such as ring learning with errors (RLWE). Such algorithms are currently understood to be resistant to a future attacker equipped with a quantum computer, but any algorithm which produces an encrypted polynomial from a source polynomial may be used. In one implementation, a single polynomial private key can be used to perform infinite lattice encryption of a large number of plaintext data. In this scenario, security is a more important consideration than performance for this step.

In some embodiments, constructing the Riemannian ciphertext space, includes performing the same process as described in relation to blocks 304, and 306, but performed with the polynomial public key obtained from block 310. The process, for example, can include obtaining a product of a radial basis function with the polynomial public key to construct a Riemannian radial basis kernel RB_{cipher}, and performing the infinite lattice encryption expressed as R_{cipher}=RB_{cipher}(RBₚₗₐᵢₙ(Rₚₗₐᵢₙ)).

Any amount of encrypted data in R_{cipher} can be sent to an untrusted third party. So long as a secure algorithm was used to encrypt the private key at block 310, and the third party does not possess the private key or prior knowledge about the plaintext dataset, it will be impossible, nearly impossible or impractical for the third party to decrypt data in R_{cipher}, using a practical amount of computing power. Nonetheless, the third party can still use the data in R_{cipher} to solve for operator identities, such as additive and multiplicative identities, in order to perform calculations on data in R_{cipher}, since the geometry of R_{cipher} preserves the relative order and magnitude of Rₚₗₐᵢₙ.

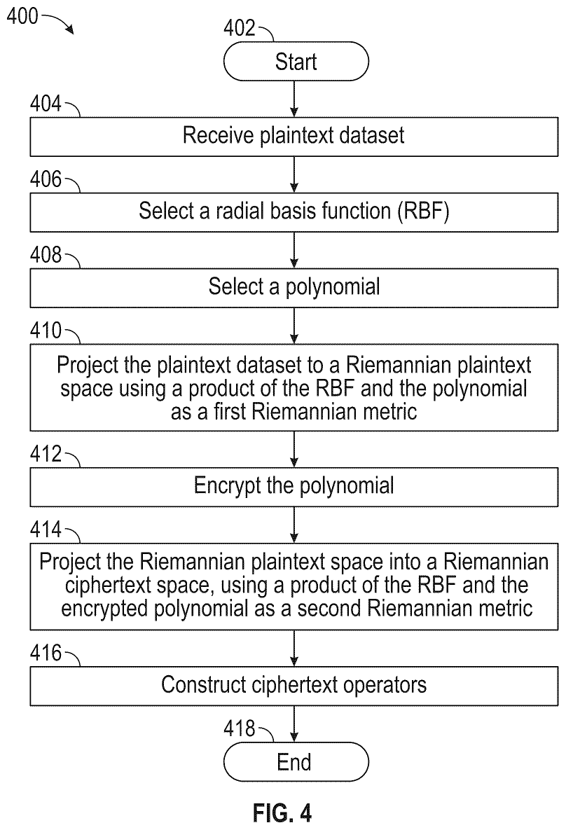

FIG. 4 illustrates a flowchart of an example method 400 of an infinite lattice encryption, according to an embodiment. The method starts at step 404. At step 406, a plaintext dataset is received. At step 406, a radial basis function (RBF), is selected. At step 408, a polynomial is selected. At step 410, the plaintext dataset is projected into a Riemannian plaintext space using a product of the RBF and the polynomial, as a first Riemannian metric. At step 412, the polynomial is encrypted. Any robust encryption algorithm can be used. As advancements in the field of encryption produce more robust encryption algorithms, those algorithms can be used in steps 412. In particular, quantum-resistant encryption algorithms can be beneficial in several industries. At step 414, the Riemannian plaintext space is projected into a Riemannian ciphertext space, using a product of the RBF and the encrypted polynomial, as a second Riemannian metric. In some embodiments, the RBF used in step 414 can be different than the RBF used in step 410. In other embodiments, the RBF in both steps 410 and 414 can be the same. At step 416, one or more operators of the Riemannian ciphertext space are constructed as described above. In some embodiments, an external entity may perform the step 416. Alternatively, the external entity may receive the operators. The method ends at step 418.

### Example Applications of the Described Encryption

Encryption at rest: Alice can encrypt private data, using the described embodiments. Bob cannot decrypt or read the private data, even if Bob finds access to the private data (e.g., by accident or by hacking).

Encryption in transit: Alice can encrypt a private message, using the described embodiments and can send the encrypted private message to Bob. Eve, who is listening in, cannot decrypt or read the private message. In this scenario, Alice and Bob agree on a private key, in such a way that Eve cannot guess or generate the private key. For example, Alice and Bob can use the Diffie-Hellman key exchange algorithm. The described embodiments can be used to encrypt the data which Alice sends to Bob and might provide some performance benefit depending on the form of the data.

Encryption during analysis: Alice is the chief information officer (CIO) of a network of hospitals and Bob is a medical researcher. Alice can share with Bob, patient medical data, encrypted with the described embodiments, while still complying with health insurance portability and accountability act (HIPAA). HIPAA prohibits her Alice from disclosing unencrypted patient information. Alice can encrypt the patient data, using the described embodiments, and Bob can use the described embodiments (e.g., homomorphic operators to perform homomorphic computation on the encrypted patient data).

End-to-end encryption with content scanning: The compliance department of a company is charged with ensuring that the company's applications, for example, a messenger application, which features end-to-end encryption, comply with a new regulation. Determining compliance in this and similar scenarios may include having to scan and search the messages for prohibited content. The described embodiments can be used to perform compliance audit computations on the company's applications. For example, in the case of the messenger application, to determine compliance, the messenger application can be designed to route all messages through a server. The server can utilize one or more zero-knowledge proof scanners, implemented, using the described embodiments, to verify that no prohibited content is present. For example, embodiments of infinite lattice encryption can be used to construct a general-purpose zero-knowledge proof, which can be applied to scanning the encrypted content of the messenger, by performing homomorphic computation on the encrypted messages.

String Cryptography with Infinite Lattice Cryptography and Other Quantitative Encryption Algorithms

The embodiments of infinite lattice cryptography can be used with or extended to applications performing string encryption. A string is a sequence of characters like “abcde” or “épistème” or “ [symbol] .” One approach to encrypting strings is to use a one-way hash function, like secure hash algorithm (SHA) 256 or similar algorithms. The resulting hash still possesses a byte-wise order which can be used to store the hash in a database collection, like in a self-balancing tree, but it is unrelated to the collation of the input (e.g. the hash value of the strings “a,” “A” and “a” are unrelated even though they typically have an identical collation order). This can be problematic for applications like machine learning which rely on measures of string similarity. For example, given an encrypted database of movie reviews which contains both text and a quantitative score (e.g., one to five stars), it is possible to perform sentiment analysis on text which cannot be decrypted because it may contain personally identifiable information (PII), but only if the text encryption scheme maintains quantitative relationships between strings in the same way that the numeric encryption scheme does.

A general-purpose cryptosystem can be more broadly applicable if it supports cryptographic operations on strings. Strings are sequences of characters in a standard character set like ASCII or UTF-8. String cryptography poses challenges that the quantitative encryption algorithms do not address. For example, homomorphic string encryption requires each character in a string to be comparable to all other characters, but every plaintext character requires an unlimited number of unique, random ciphertext representations to avoid leaking information about the plaintext via the ciphertext. For example, if the letter “e” always has the same ciphertext representation, an attacker can easily determine its plaintext value.

One fundamental operation, which must be preserved to encrypt a character set so that a collection of strings using a plaintext character set may be mapped onto an equivalent collection using an encrypted character set, is collation according to some predefined order. For example, the standard English collation sequence is case-insensitive and treats “ch” as a two-letter sequence, while the standard Czech collation sequence treats “ch” as a single letter ordered between “h” and “i.” There are multiple different popular collation orders for non-phonetic scripts, like Chinese. Some Unicode characters like, ″, the American standard code for information interchange (ASCII) double quotation mark, are equivalent to others, like left and right quotation marks, which are not equivalent to each other. It may also be convenient to preserve other script-specific operations such as case-sensitive comparison, diacritic-insensitive comparison, character classification (e.g. in order to detect whitespace), sequence replacement (or templating), etc. The described embodiments of infinite lattice photography can be used in combination with other described embodiments below to perform effective string cryptography, while addressing the challenges identified above.

In one embodiment, a string encryption method can include steps 1-9. Step 1 includes gathering a plaintext dataset, Tₚₗₐᵢₙ, from T where T is the set of all strings which can be constructed using a given character set such as UTF-8. In other words, the plaintext dataset Tₚₗₐᵢₙ is the string to be encrypted. For example, the sentence, Tₚₗₐᵢₙ can be the string, “This is a book.” Step 2 includes, choosing a collation function, collate (t₁, t₂) over all T. The collation function collate, accepts as input two substrings t₁, t₂ and returns their order (which string occurs first in the given collation). Step 3 includes constructing a set TSₚₗₐᵢₙ of all substrings of all strings in Tₚₗₐᵢₙ. For example, if the set Tₚₗₐᵢₙ is the sentence, “This is a book,” TSₚₗₐᵢₙ includes substrings, such as “T,” Th,” “Thi,” “This,” “This_,” “_i,” “_is,” “_is_,” “This_is,” “This_is_,” “his,” “is_a,” and many more. Step 4 includes collating the set of substrings TSₚₗₐᵢₙ, using the collate function, collate, chosen at step 2.

Step 5 includes selecting a first set of random numbers X=xₙ from the set of real numbers R, where n=[0, N], and N=|TSₚₗₐᵢₙ|, where |TSₚₗₐᵢₙ| is the size of the set TSₚₗₐᵢₙ. In other words, the first set of random numbers X includes N number of random numbers, xₙ, equal to the number of substrings constructed in step 3. Step 6 includes sorting the first set of random numbers X. Step 7 includes constructing a bijective map of the collated substrings TSₚₗₐᵢₙ to the sorted first set of random numbers X. Bijective in this context refers to a one-to-one relationship in the mapping. The bijective mapping between the set of collated substrings TSₚₗₐᵢₙ and the set of sorted random numbers X can be denoted as TSₚₗₐᵢₙ→X. In this manner, if the collated TSₚₗₐᵢₙ includes the collated_substrings n=[0, N], each collated substringₙ is mapped to a sorted_xₙ.

Step 8 includes selecting a second set of random numbers Y from the set of real numbers R, and constructing a mapping TSₚₗₐᵢₙ→Y or TSₚₗₐᵢₙ→Rₚₗₐᵢₙ. In other words, in addition to being mapped to a sorted random number from the first set of random numbers X, each substringₙ in the set TSₚₗₐᵢₙ is mapped to a random number yₙ from the second set of random numbers. The x-coordinate mapping being a mapping to a sorted set, preserves the collation order of the collated substrings in later encryption steps. The set of real numbers for the mappings discussed here is chosen as an example for illustration. In other embodiments, any self-consistent coordinate system may be used for these mappings. For example, polar coordinates may be used by constructing a bijective map between substrings and a random angle θ, then mapping each instance of each substring by a random polar coordinate [r, θ]. Step 8 also includes randomly mapping the substrings in TSₚₗₐᵢₙ with a random two-dimensional vector [xₙ, yₙ], where xₙ is chosen from the mapping performed at step 5, and yₙ is from the mapping performed earlier at step 8. In other words, each substring, substringₙ is mapped to a two-dimensional vector [xₙ, yₙ], where xₙ is the sorted random number, xₙ, from the first set of random numbers X, that was mapped to the substringₙ, and yₙ is a random number yₙ, that was mapped to the substringₙ, from the second set of random numbers Y. The xₙ values being from a sorted set preserve the collation of the collated substrings. Step 9 includes constructing a set of ciphertext data, R_{cipher}, by homomorphic encryption of R. For example, embodiments of infinite lattice cryptography described above, geometric encryption, and/or other robust quantitative encryption algorithms can be used.

In this manner, through steps 1-8, the original string Tₚₗₐᵢₙ is broken up and mapped into a set of two-dimensional quantitative vectors. In effect, Steps 1-8 convert the string Tₚₗₐᵢₙ into quantitative data, which can be encrypted, using the described embodiments of infinite lattice cryptography, described above, or by other robust quantitative encryption algorithms. Any encryption algorithm that can accept as input a set of vectors can be used. For example, geometric encryption algorithms can also be used for encrypting the set of vectors generated after step 8. The conversion into quantitative data, according to the described embodiments of steps 1-8, increases the entropy of the original string, Tₚₗₐᵢₙ, thereby increasing the difficulty of guessing the mapping from ciphertext data. In other words, string cryptography, according to the described embodiments, can include two aspects. The first aspect includes a conversion of a string into quantitative data, which were described in steps 1-8 above. A second aspect of string cryptography can include encrypting the quantitative data, using a robust quantitative encryption algorithm, such as the infinite lattice cryptography embodiments, described above. A low-entropy conversion to quantitative data, without utilizing steps 1-8, can weaken the overall string cryptography, no matter how robust the quantitative encryption algorithm may be in the second aspect. For example, if in the first aspect of string cryptography, the characters are always mapped to the same quantitative data, an attacker can utilize techniques, such as natural language character occurrence frequency analysis to guess the mapping between the quantitative data (e.g., real numbers) and the natural language characters, thereby guessing the plaintext data. By contrast, steps 1-8 describe a high-entropy conversion to quantitative data, which increase the resilience of the overall encryption to hacking attacks. Each instance of a character (e.g., a substring) is mapped to a random vector [x, y]. For example, each instance of the letter “e,” or the word, “the,” which are frequently occurring in the English language, are mapped to a different vector [x, y], thereby preventing the ciphertext from leaking statistical data describing the plaintext.

Using the described two-aspect string cryptography, the operations of collating and concatenating lists of ciphertext vectors can be preserved, with reduced risk, or without the risk of an attacker gaining information about the plaintext by comparing enciphered strings to a publicly available distribution (e.g., of letters or substrings in the English language text). The fidelity of the splitting operation (the inverse of concatenation) can optionally be preserved by restricting the set of substrings TSₚₗₐᵢₙ to single characters, at the cost of requiring more randomness, (or longer vectors) in Rₚₗₐᵢₙ to maintain the same ciphertext entropy. In some embodiments, restricting the set of substrings can include defining a classification function, where the classification function applies one or more restrictions to apply to a selection of the substrings present in the class (e.g. for whitespace). The classification function can also be defined by a linear function defined in R_{cipher} by pre-processing Rₚₗₐᵢₙ, so that the linear function admits a consistent linear map between classes (e.g., lower-case to upper-case and vice versa).

Character classes like capital versus lowercase, text versus whitespace, independent vs. combining character, etc. may be preserved by restricting the set of substrings TSₚₗₐᵢₙ to those which have a distinct identity with respect to each character class defined on R_{cipher}. However, defining character classes on ciphertext should be done with care, as it can allow an attacker to derive statistics about the plaintext. For example, in some scripts the ability to classify independent versus combining characters can reveal the distribution of vowels in the plaintext.

A decryption algorithm of the described embodiment includes decryption steps 1-4 as follows. Decryption step 1 includes using a decryption algorithm, corresponding to the encryption algorithm, used in encryption step 9 above. For example, if in step 9, a homomorphic encryption algorithm was used to encrypt the vectors, a corresponding homomorphic decryption algorithm can be used to recover the Rₚₗₐᵢₙ. In decryption step 2, each decrypted vector can be mapped to its corresponding ordinal Rₚₗₐᵢₙ→X. In decryption step 3, each decrypted ordinal x coordinate can be mapped to its corresponding substring in TSₚₗₐᵢₙ. Decryption step 4 can include concatenating the list of substrings in TSₚₗₐᵢₙ to recover the original plaintext dataset Tₚₗₐᵢₙ.

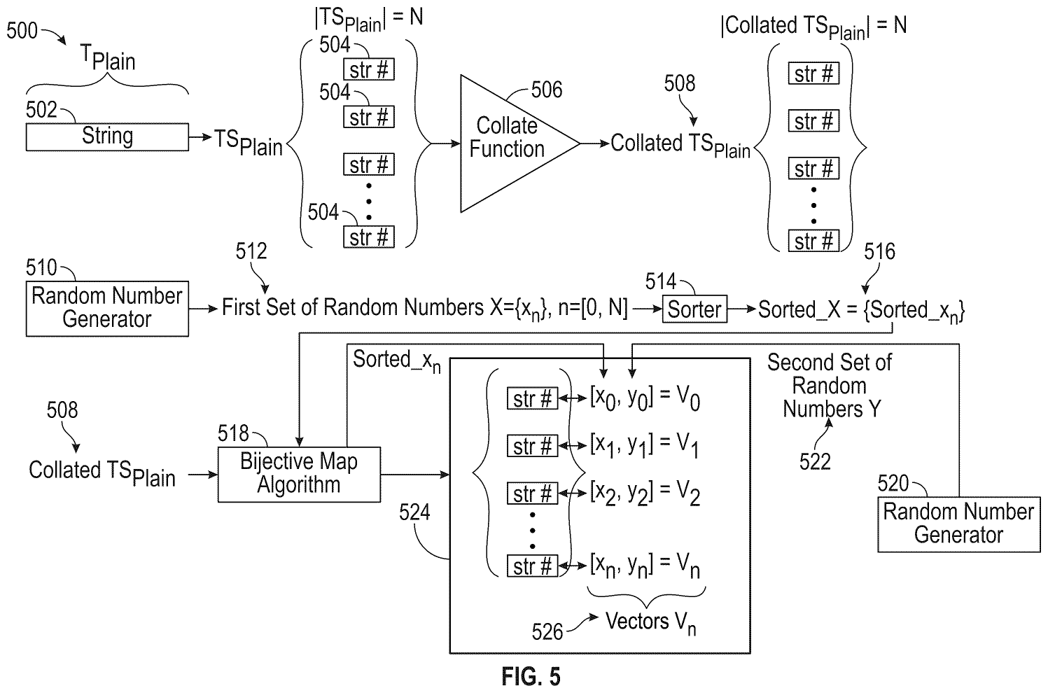

FIG. 5 illustrates a block diagram 500 of generating a high entropy quantitative data structure from a string 502. The string 502 can be broken into substrings 504. The string 502 can be the plaintext dataset Tₚₗₐᵢₙ. The substrings 504 can be the set of substrings TSₚₗₐᵢₙ. The number of substrings 504 can be “N.” A collate function 506 can accept as input the substrings 504 and generate a set of collated substrings 508.

A random number generator 510 can generate a first set of random numbers 512. The first set of random numbers 512 can be denoted by X={xₙ}, where n=[0,N]. A sorter 514 sorts the first set of random numbers 512, generating a sorted set of random numbers 516. The sorted set of random numbers 516 can be denoted by sorted_X={sorted_xₙ}, where n=[0,N].

A bijective map algorithm 518 can receive the set of collated substrings 508 and the sorted set of random numbers 516 and map each collated substring to a number from the sorted set of random numbers 516. The bijective map algorithm 518 performs its mapping in the same order as the order in the sorted set of random numbers 516. In other words, the bijective map algorithm 518 does not disturb the order of the collated strings or the sorted set of random numbers 516. Since both sets are of size “N,” the bijective map algorithm 518 can perform a one-to-one mapping between the collated substrings 508 and the sorted set of random numbers 516, without disturbing the order of the collated strings 508 or the sorted set of random numbers 516.

A random number generator 520 can generate a second set of random numbers 522. The second set of random numbers Y can be denoted by Y={Yₙ}, where n=[0,N]. A vector generator 524 can receive the mappings from the bijective map algorithm 518 and the second set of random numbers 522 and generate a vector 526 for each collated substring 508. The vector generator 524 can map each collated substring to a two-dimensional vector 526, having “x” and “y” coordinates. The x-coordinate of a vector 526 for a collated substring can be from the mapping generated by the bijective map algorithm 518. In other words, the x-coordinates of the vector 526 for a collated substring is a number from the sorted set of random numbers 516. The y-coordinate of a vector 526 for a collated substring can be from the second set of random numbers “Y.” In this manner, the vector generator 524, maps each collated substring, substringₙ to a two-dimensional vector 526, which can be denoted as Vₙ=[xₙ,yₙ].

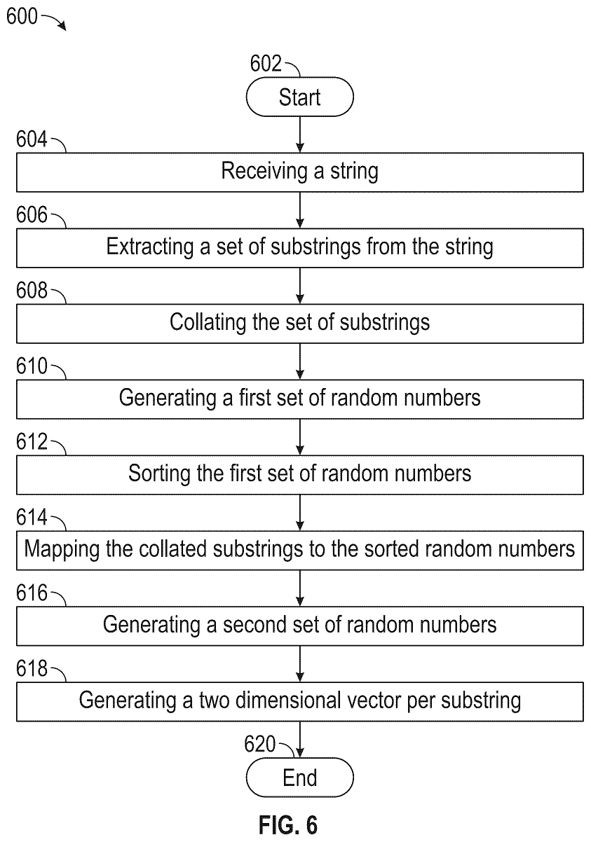

FIG. 6 illustrates a flowchart of a method 600 for high-entropy conversion of a string to quantitative data, while maintaining the collation of the string according to a selected collation order of the character set to which the string belongs. The method 600 can be used as a first aspect of string encryption according to an embodiment. The method starts at step 602. Step 604 includes receiving a string. Step 606 includes extracting a set of substrings from the string. Step 608 includes collating the set of substrings with a collate function. In some instances, step 608 includes selecting a collation function with which the substrings can be collated. For example, some languages have more than one collation order and corresponding collation functions. Step 610 includes generating a first set of random numbers. Step 612 includes sorting the first set of random numbers. Step 614 includes mapping the collated substrings to the sorted random numbers in a one-to-one bijective map. Step 616 includes generating a second set of random numbers. Step 618 includes generating a two dimensional vector 526 per collated substring. The x-coordinates of the vectors 526 are the mapped sorted random numbers from step 614, the y-coordinates of the vectors 526 are from the second set of random numbers. The method ends at step 620.

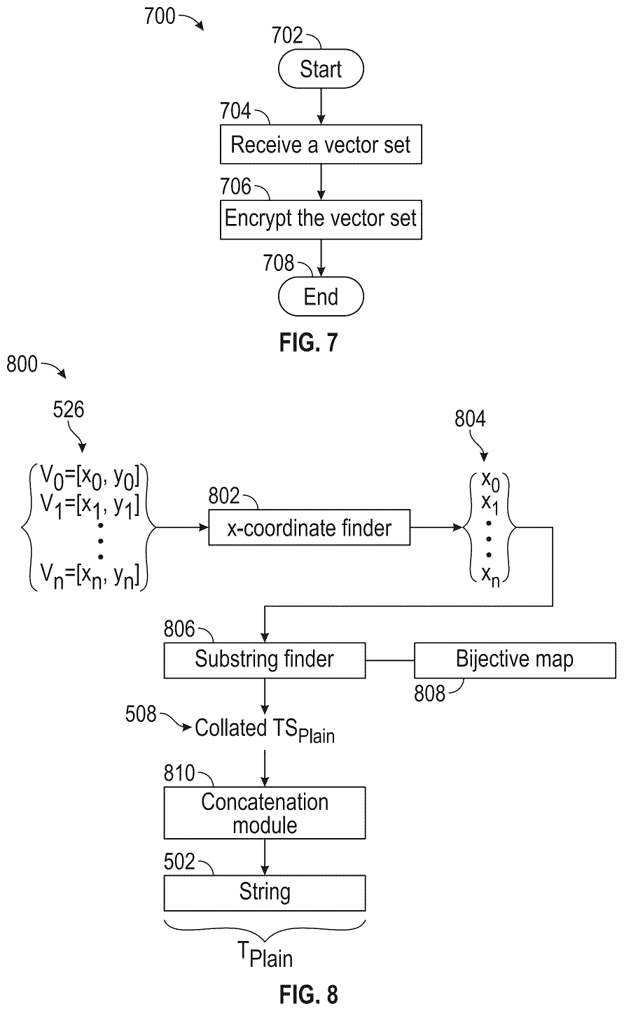

FIG. 7 illustrates a flowchart of a method 700 for encrypting the vectors 526 generated by the method 600, using a quantitative encryption algorithm. The method starts at step 702. Step 704 includes receiving the vectors 526 generated by method 600. Step 706 includes encrypting the vectors 526 with a quantitative encryption algorithm. Any encryption algorithm that can accept as input a set of two dimensional vectors can be used. The homomorphic encryption algorithms, described above in relation to the embodiments of FIGS. 1-4 are example encryption algorithms that can be used in step 706. The method ends at step 708.

FIG. 8 illustrates a block diagram 800 of a decryption technique for decrypting a string, which has been previously encrypted using methods 600 and 700. The encrypted vectors can be decrypted by a decryption algorithm corresponding to the encryption algorithm used to encrypt them. The decrypted vectors, Vₙ=[xₙ,yₙ], are the vectors 526. An x-coordinate finder 802 can extract the x-coordinates 804, x₀ to xₙ, from the vectors Vₙ. The y-coordinates can be discarded or ignored, as they were used for generating entropy in the quantification of the substrings. A substring finder 806 can use the x-coordinates and the bijective map 808 to find the corresponding substrings to each x-coordinate. The substring finder 806 can output the collated substrings 508. A concatenation module 810 can reassemble the collated substrings into the original string 502. The vectors 526 were chosen to be two-dimensional. Furthermore, the embodiments of the homomorphic encryption described in relation to FIGS. 1-4, as part of their internal operations add more dimensions to an input, such as vectors 526. Therefore, in this scenario, when the described quantitative encryption algorithms are used, no further advantage can be realized from adding more than two-dimensions when generating the vectors 526. However, if a quantitative encryption algorithm is used, which does not increase the dimensionality of the input data, then there can be advantages in increasing the dimension of the vectors 526, before encryption.

The concatenation module 810 can utilize a variety of techniques to perform substring matching and reconstruct the original string 502. One approach includes choosing an arbitrary maximum substring length “k,” and building a trie of depth “k” with pointers to the locations of each instance of each substring in the trie. A tire is a type of digital tree or prefix tree, used for locating specific keys from within a set. The keys can be substrings. A similar approach includes constructing an intermediary ordered data structure (e.g., a linked list) consisting of pointers to the substrings of length less than k. Another approach includes using the Aho-Corasick algorithm to construct the ciphertext from the plaintext. Another approach includes using the Boyer-Moore algorithm to find instances of each substring to encrypt. A similar approach includes using naive string search (e.g., in-order character-by-character comparison).

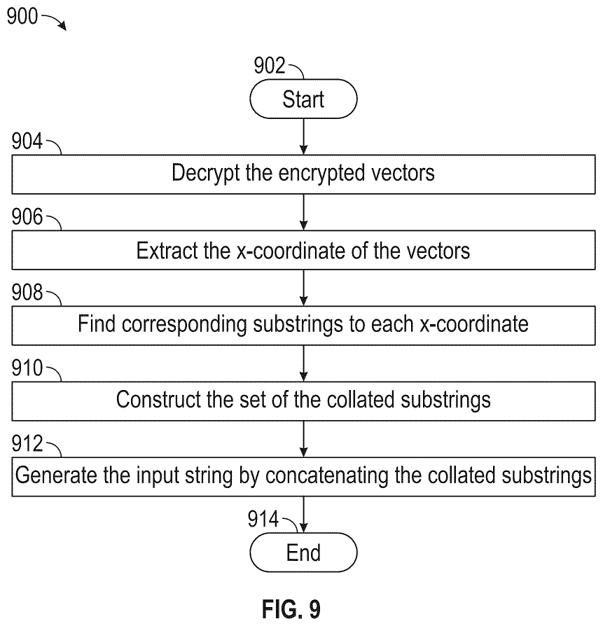

FIG. 9 illustrates a flowchart 900 of a decryption algorithm for decrypting a string encrypted using methods 600, and 700. The method starts at step 902. Step 904 includes decrypting the encrypted vectors to obtain the vectors 526. Step 906 includes extracting the x-coordinates of the vectors 526. Step 908 includes obtaining the corresponding substrings to each x-coordinates, with the bijective map that was used to map the collated substrings 508 to the sorted random numbers that make up the x-coordinates. Step 910 includes using the substrings obtained in step 908 to construct the set of collated substrings 508. Step 912 includes generating the original string 502 from the collated substrings 508. The method ends at step 914.

### Example Implementation Mechanism—Hardware Overview

Some embodiments are implemented by a computer system or a network of computer systems. A computer system may include a processor, a memory, and a non-transitory computer-readable medium. The memory and non-transitory medium may store instructions for performing methods, steps and techniques described herein.

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be server computers, cloud computing computers, desktop computer systems, portable computer systems, handheld devices, networking devices or any other device that incorporates hard-wired and/or program logic to implement the techniques.

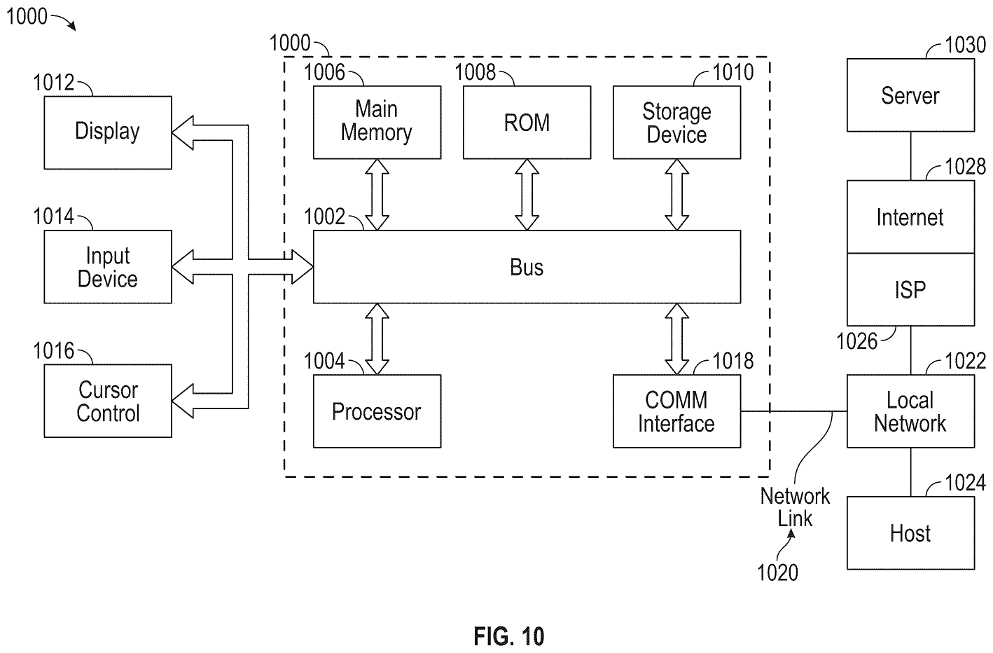

For example, FIG. 10 is a block diagram that illustrates a computer system 1000 upon which an embodiment of can be implemented. Computer system 1000 includes a bus 1002 or other communication mechanism for communicating information, and a hardware processor 1004 coupled with bus 1002 for processing information. Hardware processor 1004 may be, for example, special-purpose microprocessor optimized for handling audio and video streams generated, transmitted or received in video conferencing architectures.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid state disk is provided and coupled to bus 1002 for storing information and instructions.

Computer system 1000 may be coupled via bus 1002 to a display 1012, such as a cathode ray tube (CRT), liquid crystal display (LCD), organic light-emitting diode (OLED), or a touchscreen for displaying information to a computer user. An input device 1014, including alphanumeric and other keys (e.g., in a touch screen display) is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane. In some embodiments, the user input device 1014 and/or the cursor control 1016 can be implemented in the display 1012 for example, via a touch-screen interface that serves as both output display and input device.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical, magnetic, and/or solid-state disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the worldwide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018. The received code may be executed by processor 1004 as it is received, and/or stored in storage device 1010, or other non-volatile storage for later execution.

### Examples Related to Infinite Lattice Cryptography

It will be appreciated that the present disclosure may include any one and up to all of the following examples.

Example 1: A method comprising: receiving a plaintext dataset; selecting an order of a polynomial; selecting coefficients of the polynomial; projecting the plaintext dataset into a higher dimension plaintext space, using a first Riemannian metric; encrypting the polynomial with an encryption algorithm, generating an encrypted polynomial; and using the encrypted polynomial, as a second Riemannian metric of a ciphertext space, projecting the plaintext space into the ciphertext space.

Example 2: The method of Example 1, wherein the first Riemannian metric comprises a first product of a first radial basis function and the polynomial, and wherein the second Riemannian metric comprises a second product of a second radial basis function and the encrypted polynomial.

Example 3: The method of some or all of Examples 1 and 2, wherein the first and second radial basis functions are the same.

Example 4: The method of some or all of Examples 1-3, wherein the encryption algorithm comprises an algorithm resistant to quantum computing attacks.

Example 5: The method of some or all of Examples 1-4, further comprising: generating one or more operators in the ciphertext space.

Example 6: The method of some or all of Examples 1-5, wherein the plaintext dataset, comprises a numerical or a scaler dataset.

Example 7: The method of some or all of Examples 1-6, wherein projecting the plaintext dataset into the plaintext space and projecting the plaintext space into the ciphertext space, preserve the relative order and magnitude of elements in the plaintext dataset in the plaintext space and the ciphertext space.

Example 8: The method of some or all of Examples 1-7, wherein the encryption algorithm comprises a lattice-based cryptography algorithm.

Example 9: A non-transitory computer storage that stores executable program instructions that, when executed by one or more computing devices, configure the one or more computing devices to perform operations comprising: receiving a plaintext dataset; selecting an order of a polynomial; selecting coefficients of the polynomial; projecting the plaintext dataset into a higher dimension plaintext space, using a first Riemannian metric; encrypting the polynomial with an encryption algorithm, generating an encrypted polynomial; and using the encrypted polynomial, as a second Riemannian metric of a ciphertext space, projecting the plaintext space into the ciphertext space.

Example 10: The non-transitory computer storage of Example 9, wherein the first Riemannian metric comprises a first product of a first radial basis function and the polynomial, and wherein the second Riemannian metric comprises a second product of a second radial basis function and the encrypted polynomial.

Example 11: The non-transitory computer storage of some or of Examples 9 and 10, wherein the first and second radial basis functions are the same.

Example 12: The non-transitory computer storage of some or all of Examples 9-11, wherein the encryption algorithm comprises an algorithm resistant to quantum computing attacks.

Example 13: The non-transitory computer storage of some or all of Examples 9-12, wherein the operations further comprise: generating one or more operators in the ciphertext space.

Example 14: The non-transitory computer storage of some or all of Examples 9-13, wherein the plaintext dataset, comprises a numerical or a scaler dataset.

Example 15: The non-transitory computer storage of some or all of Examples 9-14, wherein projecting the plaintext dataset into the plaintext space and projecting the plaintext space into the ciphertext space, preserve the relative order and magnitude of elements in the plaintext dataset in the plaintext space and the ciphertext space.

Example 16: The non-transitory computer storage of some or all of Examples 9-15, wherein the encryption algorithm comprises a lattice-based cryptography algorithm.

Example 17: A system comprising one or more processors, wherein the one or more processors are configured to perform operations comprising: receiving a plaintext dataset; electing an order of a polynomial; selecting coefficients of the polynomial; projecting the plaintext dataset into a higher dimension plaintext space, using a first Riemannian metric; encrypting the polynomial with an encryption algorithm, generating an encrypted polynomial; and using the encrypted polynomial, as a second Riemannian metric of a ciphertext space, projecting the plaintext space into the ciphertext space.

Example 18: The system of Example 17, wherein the first Riemannian metric comprises a first product of a first radial basis function and the polynomial, and wherein the second Riemannian metric comprises a second product of a second radial basis function and the encrypted polynomial.

Example 19: The system of some or all of Examples 17 and 18, wherein the first and second radial basis functions are the same.

Example 20: The system of some or all of Examples 17-19, wherein the encryption algorithm comprises an algorithm resistant to quantum computing attacks.

### Examples Related to Infinite Lattice String Cryptography

It will be appreciated that the present disclosure may include any one and up to all of the following examples.

Example 1: A computer-implemented method of string cryptography, comprising: receiving a string; extracting a set of substrings from the string; collating the set of substrings; generating a first set of random numbers; sorting the first set of random numbers; mapping the sorted random numbers to the collated substrings, such that each substring is mapped to a unique random number from the first set of random numbers; generating a second set of random numbers; generating a two-dimensional vector for each substring, the two-dimensions comprising an x-coordinate and a y-coordinate, wherein the x-coordinate for a substring comprises the random number from the first set mapped to the substring and the y-coordinate comprises a random number from the second set; and encrypting the vectors with a quantitative encryption algorithm.

Example 2: The method of Example 1, wherein encrypting with a quantitative encryption algorithm comprises: generating a plaintext dataset, comprising the vectors for the substrings; selecting an order of a polynomial; selecting coefficients of the polynomial; projecting the plaintext dataset into a higher dimension plaintext space, using a first Riemannian metric; encrypting the polynomial with an encryption algorithm, generating an encrypted polynomial; and using the encrypted polynomial, as a second Riemannian metric of a ciphertext space, projecting the plaintext space into the ciphertext space.

Example 3: The method of some or all of Examples 1 and 2, wherein the first Riemannian metric comprises a first product of a first radial basis function and the polynomial, and wherein the second Riemannian metric comprises a second product of a second radial basis function and the encrypted polynomial.

Example 4: The method of some or all of Examples 1-3, wherein the first and second radial basis functions are the same.

Example 5: The method of some or all of Examples 1-4, wherein the encryption algorithm comprises an algorithm resistant to quantum computing attacks.

Example 6: The method of some or all of Examples 1-5, further comprising: generating one or more operators in the ciphertext space.

Example 7: The method of some or all of Examples 1-6, further comprising: decrypting the encrypted vectors, with a decryption algorithm corresponding to the quantitative encryption algorithm; construct the set of collated substrings from the x-coordinate of the vectors; and generate the string by concatenating the collated substrings.

Example 8: The method of some or all of Examples 1-7, wherein projecting the plaintext dataset into the plaintext space and projecting the plaintext space into the ciphertext space, preserve the relative order and magnitude of elements in the plaintext dataset in the plaintext space and the ciphertext space.

Example 9: The method of some or all of Examples 1-8, wherein the encryption algorithm comprises a lattice-based cryptography algorithm.

Example 10: A non-transitory computer storage that stores executable program instructions that, when executed by one or more computing devices, configure the one or more computing devices to perform operations comprising: receiving a string; extracting a set of substrings from the string; collating the set of substrings; generating a first set of random numbers; sorting the first set of random numbers; mapping the sorted random numbers to the collated substrings, such that each substring is mapped to a unique random number from the first set of random numbers; generating a second set of random numbers; generating a two-dimensional vector for each substring, the two-dimensions comprising an x-coordinate and a y-coordinate, wherein the x-coordinate for a substring comprises the random number from the first set mapped to the substring and the y-coordinate comprises a random number from the second set; and encrypting the vectors with a quantitative encryption algorithm.

Example 11: The non-transitory computer storage of Example 10, wherein encrypting with a quantitative encryption algorithm comprises: generating a plaintext dataset, comprising the vectors for the substrings; selecting an order of a polynomial; selecting coefficients of the polynomial; projecting the plaintext dataset into a higher dimension plaintext space, using a first Riemannian metric; encrypting the polynomial with an encryption algorithm, generating an encrypted polynomial; and using the encrypted polynomial, as a second Riemannian metric of a ciphertext space, projecting the plaintext space into the ciphertext space.

Example 12: The non-transitory computer storage of some or all of Examples 10 and 11, wherein the first Riemannian metric comprises a first product of a first radial basis function and the polynomial, and wherein the second Riemannian metric comprises a second product of a second radial basis function and the encrypted polynomial.

Example 13: The non-transitory computer storage of some or all of Examples 10-12, wherein the first and second radial basis functions are the same.

Example 14: The non-transitory computer storage of some or all of Examples 10-13, wherein the encryption algorithm comprises an algorithm resistant to quantum computing attacks.

Example 15: The non-transitory computer storage of some or all of Examples 10-14, wherein the operations further comprise: generating one or more operators in the ciphertext space.

Example 16: The non-transitory computer storage of some or all of Examples 10-15, wherein the operations further comprise: decrypting the encrypted vectors, with a decryption algorithm corresponding to the quantitative encryption algorithm; construct the set of collated substrings from the x-coordinate of the vectors; and generate the string by concatenating the collated substrings.

Example 17: The of non-transitory computer storage of some or all of Examples 10-16, wherein projecting the plaintext dataset into the plaintext space and projecting the plaintext space into the ciphertext space, preserve the relative order and magnitude of elements in the plaintext dataset in the plaintext space and the ciphertext space.

Example 18: The non-transitory computer storage of some or all of Examples 10-17, wherein the encryption algorithm comprises a lattice-based cryptography algorithm.

Example 19: A system comprising one or more processors, wherein the one or more processors are configured to perform operations comprising: receiving a string; extracting a set of substrings from the string; collating the set of substrings; generating a first set of random numbers; sorting the first set of random numbers; mapping the sorted random numbers to the collated substrings, such that each substring is mapped to a unique random number from the first set of random numbers; generating a second set of random numbers; generating a two-dimensional vector for each substring, the two-dimensions comprising an x-coordinate and a y-coordinate, wherein the x-coordinate for a substring comprises the random number from the first set mapped to the substring and the y-coordinate comprises a random number from the second set; and encrypting the vectors with a quantitative encryption algorithm.

Example 20: The system of Example 19, wherein encrypting with a quantitative encryption algorithm comprises: generating a plaintext dataset, comprising the vectors for the substrings; selecting an order of a polynomial; selecting coefficients of the polynomial; projecting the plaintext dataset into a higher dimension plaintext space, using a first Riemannian metric; encrypting the polynomial with an encryption algorithm, generating an encrypted polynomial; and using the encrypted polynomial, as a second Riemannian metric of a ciphertext space, projecting the plaintext space into the ciphertext space.

Executable Encryption with Infinite Lattice Cryptography (ILC)

Executables are computer programs that have a source code. The source code typically is written in a programming language, adhering to formal grammar rules, as defined in that programming language. A compiler translates the source code into a lower-level, machine-readable executable, which can be executed on a host, such as a computer or a computing device. Examples include desktop, or laptop computers, tablets or mobile computing devices and others. Encrypting an executable can be useful in various scenarios. For example, a computer program can be distributed and executed on a computer that is not necessarily owned by a trusted party. When an executable is encrypted by the described embodiments, the unknown party, executing the computer program, does not gain insight into the purpose or significance of the underlying operations and numbers performed by the encrypted computer program. To an attacker observing the runtime operations of an encrypted executable, the operations do not present a cohesive whole, from which the purpose and significance of the encrypted computer program can be determined.

Executable code is often distributed in an obfuscated form, meaning that its contents are deliberately obscured so that it will be difficult to reassemble into human-readable source code. However, obfuscation is not encryption and cannot distinguish which information is and is not recoverable by a third party. For example, de-obfuscation procedures are commonly used by security researchers to analyze malicious software to determine authorship and the relationships between authors. Robust executable encryption implements, not simply encrypting a field of numbers while preserving their basic quantitative relationships, but encrypting formal grammar of the executable, as well. In one example of a robust executable encryption, according to an embodiment, the formal grammar of an encrypted executable may be translated to points on an encrypted field.

In one respect, a formal grammar is a lambda calculus, a set of functions λ on variables x∈X, which may be reduced (e.g., to compile a program to a sequence of low-level operations) by α-conversion, renaming with respect to a specific namespace scope, and β-reduction or currying, which transforms a callable function with multiple arguments into a chain of functions each with a single argument. For the purposes of encryption, there is no computable function which can prove or disprove the equivalent reductions of two distinct reducible functions in the lambda calculus of a formal grammar. This means that it is possible to compile a source code into an executable encrypted representation which contains no significant sequences of repeated instructions. The space efficiency costs, in terms of how many bytes are needed to represent the encrypted executable, are generally acceptable in practical applications. Encrypting an executable program, then, is similar to encrypting a string, in the sense that executable encryption can replace frequently-used sections of a plaintext binary (a compiled program) with many different functionally equivalent ciphertexts, just like string encryption replaces frequently-repeated substrings with many different ciphertext vectors all representing the same string. A difference between executable encryption and string encryption is that executable encryption imposes a prescriptive grammar on the program to be encrypted in order to support a much more elaborate pre-processing step (compilation), which can produce an encrypted binary. The encrypted binary does not admit decryption operations, regardless of how much information an attacker has about the encrypted program, so that no part of the encrypted program can be decrypted or usefully altered.

An executable encryption technique, according to some embodiments, utilizes an executable graph. A computer program can be represented as an executable graph, where the nodes of the graph are operations of the computer program, and the edges of the graph are the function calls of the computer program. In some implementations of the executable encryption, not all nodes are encrypted. For example, conditional branches (“if” statements), interactions with the host resources (such as memory, file system, network and input/output operations) and user interactions, may be skipped. In these implementations, executable encryption includes encrypting the data which a computer program operates on and the underlying relationships therein. In other words, encrypting an executable program, as opposed to merely obfuscating it, includes compiling the executable to a form which behaves non-deterministically from the perspective of an adversary with full access to the host device executing the encrypted program.

In a computer system, the sequence of instructions for the computer system processor to perform the instructions is stored on the stack (a last-in/first-out queue), while large persistent data are stored in the heap (a table which allows retrieving or overwriting a value based on its address in memory). An encrypted executable still schedules instructions on the stack and stores data in the heap. In this scenario a compilation-encryption process (distinct from executable encryption) provides protection for masking the memory operational behavior (stack and heap interactions) from leaking information about the function or structure of the encrypted program.

Additionally, most software applications depend on run-time input to determine run-time behaviors or output. The same paired codomain used by Infinite Lattice Cryptography to support zero-knowledge proofs may be used to implement behavior which depends on user input. Optionally, the user input may be encrypted using Infinite Lattice Cryptography with a pairing function known to both the implementor of the encrypted executable and the user, but not present on the host device, running the computation. As in any zero-knowledge proof, some constraining of the interaction with the paired data is performed, in order to prevent an attacker from analyzing the encrypted data (in this case, the encrypted program).

As in the case of memory and file I/O, an adversary with full access to the host operating system can observe the network I/O operations performed by the encrypted executable and potentially learn information about the encrypted program. It may not be possible to encrypt the addresses of network destinations at compile-time, because the host network interface requires plaintext address information in order to negotiate a connection. Support for an encrypted network topology can nonetheless be provided, by various techniques in combination with encrypting the program. For example, an “onion routing” system such as Tor, or a combination of encrypted domain names and dynamic routing can be used in combination with the program encryption systems and methods described herein. In practice, data sent over the network will itself be encrypted, either in the same ciphertext domain as the program data or in a paired codomain, as in the case of user I/O. However, the implementor of the described executable encryption systems and methods, is free to generate plaintext data and send the data over the network if they choose to, without substantially exposing the encrypted program.

The described executable encryption technique is implemented where no operations have side-effects. Having no side-effects can include the scenario, where the parameters valid for any operation are numeric data encrypted by infinite lattice cryptography (ILC), strings encrypted by ILC, and functions of those numbers and strings. The lack of side-effects can include the scenario where all operations depend on, at least, one runtime parameter. In this manner, popular object-oriented languages can be used to implement a framework which allows implementing encryptable programs in a way that matches the idiomatic expression of the programming language, including its object-oriented constructs.

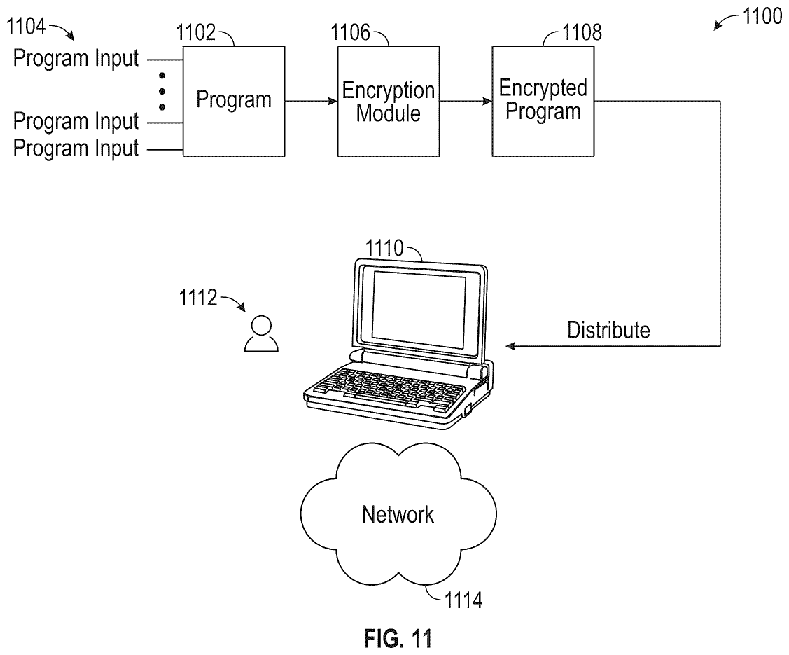

FIG. 11 illustrates an environment 1100 of generating and distributing an encrypted computer program, according to an embodiment. The program 1102 can include a series of instructions that when compiled can be executed by one or more processors. The program 1102 can receive program inputs 1104, at or prior to runtime operations. An encryption module 1106 can include systems and methods for receiving the computer program 1102, encrypting the computer program, and generating an encrypted program 1108. The encrypted program 1108 can be distributed to a host computer 1110, where it can be executed by one or more processors of the host computer 1110. A user 1112 has access and control over the host computer 1110. The encrypted program 1108 can also access one or more networks 1114, via a network interface facility of the host computer 1110. The user 1112 is an unknown user, who may in some instances be an attacker, attempting to decrypt the encrypted program 1108 and determine its significance and overall data operations. In other instances, the user 1112 may be a legitimate user, not necessarily attempting to decrypt the encrypted program 1108.

Executable encryption operations can include gathering data of the computer program 1102. This can include various instruction lines, program operations, function calls, numerical and string data, as well as program input 1104 data. The program input 1104 can be received at runtime, but the data of the program input 1104, for example, their types, their identifiers, etc. can be gathered by the encryption module 1106 for encryption operations.

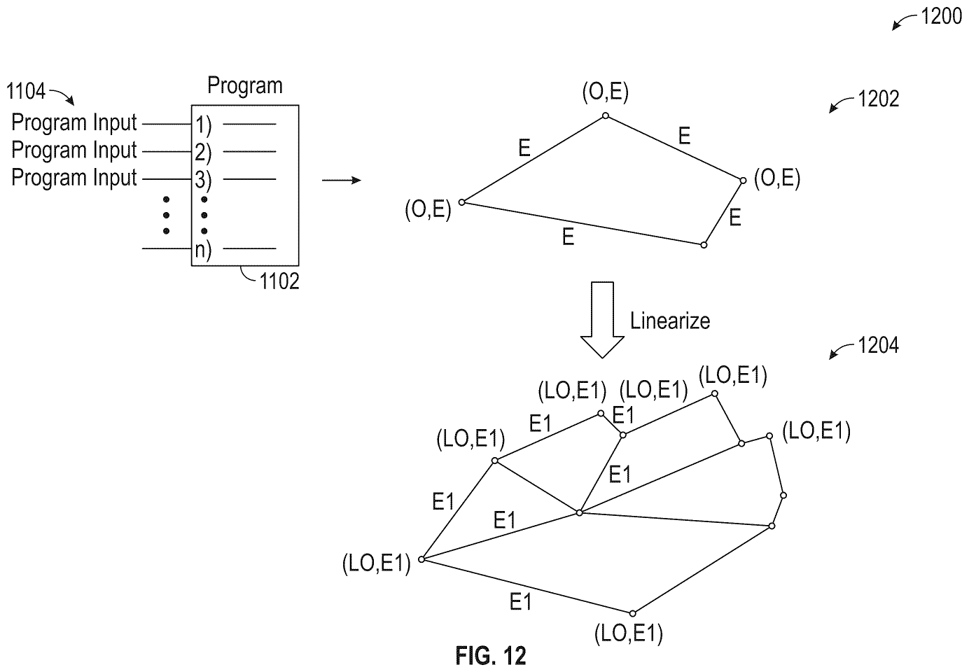

FIG. 12 illustrates diagrams 1200 of graphs that are generated from a computer program, as intermediary steps for generating an encrypted program. The program 1102 can be converted to a graph of operations 1202 (O, E), where O is the set of all operations and E is the set of all edges between the operations. The edges can represent function calls to and from an operation. The nodes of the graph can also include constants and/or variables. The graph of operations 1202 can also be generated in part by replacing the loop operations (e.g., “for” and “while”) with tail operations, which conditionally select either the next operation after the loop (“break”) or the initial operation of the loop (“continue”). The encryption operation of the encryption module 1106 can in part include linearizing the graph of operations 1202 and generating a linearized graph of operations (LGO) 1204. The LGO 1204 can be generated by currying operations, such that each edge represents a function call with one parameter, pₒ. The LGO 1204 can include nodes, where each node is a linearized operation LO, connected to other nodes LO via edges E1. Each edge E1 is a function call with one parameter, pₒ.

Executable encryption operations further include constructing or choosing an encryption co-domain for the purpose of creating pairings with the program instructions and statements, where random elements in the encryption co-domain can pair with the program instructions and statements, and program data, in order to hide or encrypt the identity of those program elements. Unlike entropy of the string data, the entropy of a computer program, for the purposes of encryption, cannot be assumed to be constant. The variability of entropy of the computer program data can be considered for the encryption purposes, in order to determine the multiple variations of a given plaintext node, which can be present in the ciphertext. Encryption of a computer program, therefore, can include steps to estimate the input state entropy number of each operation in the LGO 1204, to estimate the number of variations of each operation and to pair each variation with a random identifier from the encryption co-domain. In some embodiments, the set of real numbers R can be selected as the encryption co-domain, from which random numbers can be paired with program data.

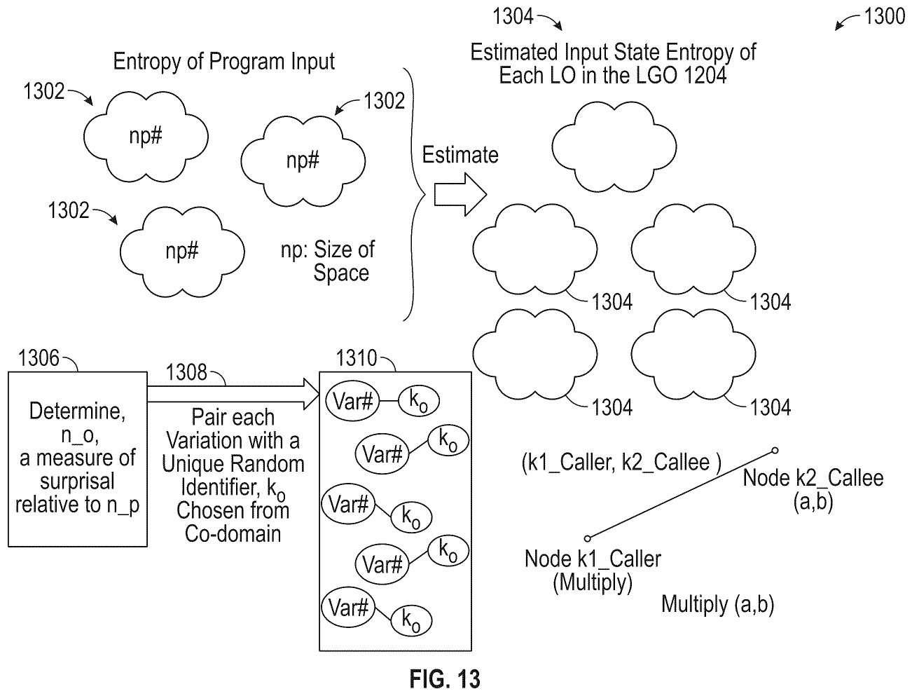

FIG. 13 illustrates diagrams 1300 of example operations that can be performed in some embodiments of executable encryption. Entropy 1302 of each program input 1104 can be estimated. A parameter “np #” can represent the size of each entropy 1302 of each program input 1104. The size of each entropy 1302, or the “np #” parameter of the entropy 1302 can be used to estimate an input state entropy of each linearized operation LO in the LGO 1204, generating estimated input state entropies 1304 of each linearized operation LO in the LGO 1204.

Various techniques can be used to determine the number of variations of each operation in the LGO 1204. In some embodiments, the executable encryption operation can include a block 1306, which can generate a parameter n_o for each operation in the program, where n_o is a measure of surprisal, relative to the size, n_p, of the phase space of each input function in the program. The executable encryption can further include pairing operations 1308, where each operation variation is paired to a unique random identifier kₒ, chosen from the encryption co-domain. The pairing operations 1308 can generate a phase space of generated pairings 1310, where “phase” in this context refers to set of all possible variations or states of an operation that can occur in the computer program.

In one respect, each edge in the graph of operations can be represented as a tuple (k #_caller, k #_callee), where k # is the index of a node, k #_caller node is making a function call to k #_callee). As an example, the operation “multiply (a, b)” includes two nodes. The node k1_caller is the multiply operation, and the node k2_caller is the multiplication parameters “a” and “b”). The edge connecting node k1 to node k2 is the tuple (k1_caller, k2_callee). When the graph of operations is linearized as part of the executable encryption operations, the operation “multiply (a, b)” can include more than two nodes.

For each edge tuple (k_caller, k_callee), executable encryption can include replacing each function call (e.g., each edge in the LGO 1204) with a choice of k_callee, conditional on the input of the operation embedded in the edge, and k_caller. In some embodiments, k_caller can be replaced by taking the modulo of the product of a hash of the input and k_caller, where “input” is the input to the operation embedded in the edge (e.g., k_caller input). As an example, the operation “multiply (a, b)” has two inputs, which the k_caller (“multiply”) must resolve by executing the other nodes in the graph that yield the K_callees, “a” and “b.” The advantage of the modulo operation is to limit the result of the hash operation to the number of available options computed in block 1306.

Additionally, the executable encryption includes encrypting constant numbers with the ILC operations as described above in relation to encryption of numerical data and encrypting text data with the ILC operations, as described above in relation to encryption of string data using ILC.

The executable encryption operations include generating a graph of operations from the computer program, G_plain, and encrypting the G_plain to generate a G_cipher. An attacker who has access to G_cipher, at runtime, still cannot determine the contents of G_plain, even if the attacker has full access to the host computer, running the encrypted executable G_cipher. The attacker cannot determine what the program is doing or is meant to do. For example, when the processor of the host computer receives an instruction to add two numbers, an attacker who intercepts this instruction does not gain insight into the significance of the numbers being added, or the significance of the instruction or sequence of instructions, pointer addresses, or other program actions. Executing G_cipher may require a minimal runtime, which is used to translate operations into machine code.

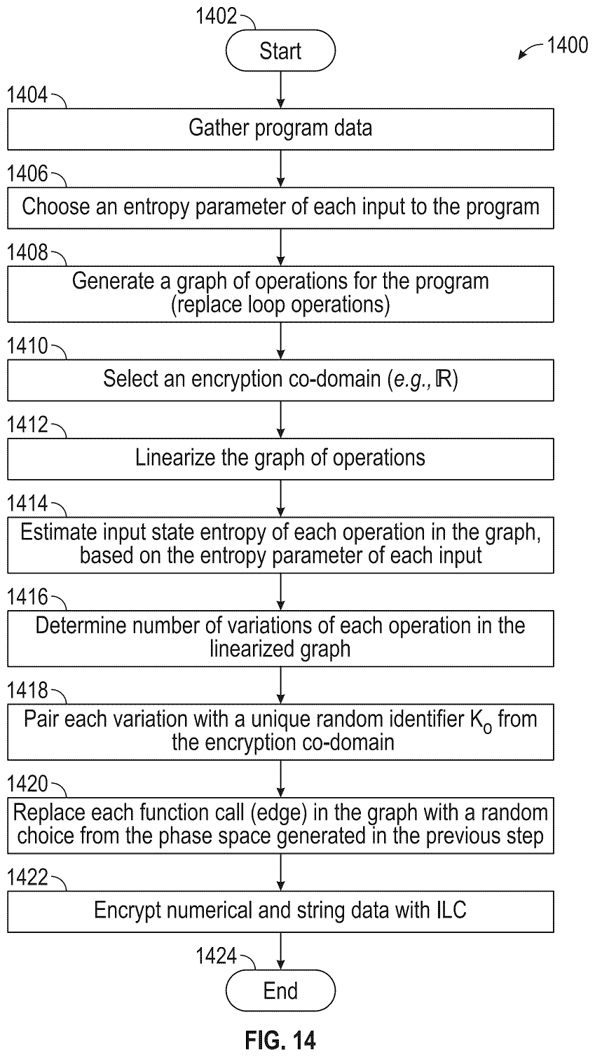

FIG. 14 includes a method 1400 of executable encryption, according to an embodiment. The method starts at step 1402. At step 1404, various program data is gathered. Program data can include program inputs, instructions, statements, operations, variables, constants, numerical or string data, or any other text, string, or number that make up the computer program. Step 1406 includes choosing an entropy parameter, nₚ, for each input to the program. Step 1408 includes generating a graph of operations for the program, where each node is an operation of the program and an edge connects nodes that are related to one another via a function call. Generating a graph of operations additionally can include replacing loop operations (e.g., “for,” “while,” etc. with tail operations, which conditionally select either the next operation, after the loop (“break”), or the initial operation of the loop (“continue”).

Step 1410 includes selecting an encryption co-domain, for encryption pairing in later steps. In some embodiments, the encryption co-domain can be selected from the set of real numbers R. Step 1412 includes linearizing the graph of operations. Linearization can be accomplished by performing currying operations such that after currying operations each edge represents a function call with one parameter, “pₒ.”

Step 1414 includes estimating the input state entropy of each operation in the graph, based on the entropy parameter, nₚ, of each program input. Step 1416 includes determining the number of variations of each operation in the linearized graph. In one embodiment, the number of variations of each operation can be determined by computing a parameter n_o, which is a measure of surprisal, relative to the size, n_p of the phase space of each input function in the program. Step 1418 includes pairing each variation with a unique random identifier, kₒ, chosen from the encryption co-domain. Step 1420 includes replacing each function call, or edge, in the graph with a random choice from the phase space generated at step 1418. Step 1422 includes encrypting any numerical data in the graph with numerical ILC embodiments, described above, and encrypting any string with string ILC embodiments, described above. The method ends at step 1424.

The method 1400 can produce an encrypted executable with various advantageous properties. For example, the path through the graph of operations is nearly acyclic for all possible input states. An attacker cannot determine any information about the function of the program by observing how it handles a single input state. Furthermore, the path through the graph of operations is unrelated to any similarity or difference between different input states. In this sense, the encrypted executable behaves non-deterministically. Therefore, an attacker cannot determine any information about the function of the program by observing how it handles multiple different input states. Additionally, there is practically no way to modify any part of the program without corrupting it entirely. As described earlier, executing the encrypted program can require a minimal unencrypted runtime which can be responsible for loading operations based on their unique IDs in the graph.

Examples Related to Executable Encryption with ILC

It will be appreciated that the present disclosure may include any one and up to all of the following examples.

Example 1: A method of executable encryption, comprising: gathering a computer program data; generating a graph of operations of the computer program, wherein each node is an operation of the computer program and each edge is a function call in the computer program; selecting an encryption co-domain; determining variations of each operation; generating a phase space of pairings, each pairing comprising an operation variation paired with a random number from the encryption co-domain; replacing each edge in the graph of operations with a random choice from the pairing; encrypting the numerical data in the graph with numerical infinite lattice cryptography; and encrypting string data in the graph with string infinite lattice cryptography.

Example 2: The method of Example 1, wherein numerical infinite lattice cryptography comprises: generating a plaintext dataset, comprising the vectors for the substrings; selecting an order of a polynomial; selecting coefficients of the polynomial; projecting the plaintext dataset into a higher dimension plaintext space, using a first Riemannian metric; encrypting the polynomial with an encryption algorithm, generating an encrypted polynomial; and using the encrypted polynomial, as a second Riemannian metric of a ciphertext space, projecting the plaintext space into the ciphertext space.

Example 3: The method of some or all of Examples 1 and 2, wherein the first Riemannian metric comprises a first product of a first radial basis function and the polynomial, and wherein the second Riemannian metric comprises a second product of a second radial basis function and the encrypted polynomial.

Example 4: The method of some or all of Examples 1-3, wherein the first and second radial basis functions are the same.

Example 5: The method of some or all of Examples 1-4, wherein string infinite lattice cryptography comprises: receiving a string; extracting a set of substrings from the string; collating the set of substrings; generating a first set of random numbers; sorting the first set of random numbers; mapping the sorted random numbers to the collated substrings, such that each substring is mapped to a unique random number from the first set of random numbers; generating a second set of random numbers; generating a two-dimensional vector for each substring, the two-dimensions comprising an x-coordinate and a y-coordinate, wherein the x-coordinate for a substring comprises the random number from the first set mapped to the substring and the y-coordinate comprises a random number from the second set; and encrypting the vectors with a quantitative encryption algorithm.

Example 6: The method of some or all of Examples 1-5, further comprising linearizing the graph of operations by performing currying operations, wherein currying generates a linearized graph, having nodes, wherein each node comprises an operation with one variable.

Example 7: The method of some or all of Examples 1-6, wherein determining variations of each operation comprises: estimating an input state entropy of each operation in the graph of operations, based on an entropy parameter of each input; and generating a measure of surprisal, n_o, relative to the estimated input state entropy.

Example 8: The method of some or all of Examples 1-7, wherein each edge comprises a tuple (k_caller, k_callee), wherein k_caller is the index of an operation node and k_callee is an index of an input of the operation; and replacing comprises: selecting a random k_callee and a k_caller from the phase space of pairings.

Example 9: The method of some or all of Examples 1-8, wherein the replacing further comprises taking a modulo of a product of a hash of the input, k_callee and the k_caller.

Example 10: The method of some or all of Examples 1-9, wherein the encryption co-domain is the set of real numbers.

Example 11: A non-transitory computer storage that stores executable program instructions that, when executed by one or more computing devices, configure the one or more computing devices to perform functions comprising: gathering a computer program data; generating a graph of operations of the computer program, wherein each node is an operation of the computer program and each edge is a function call in the computer program; selecting an encryption co-domain; determining variations of each operation; generating a phase space of pairings, each pairing comprising an operation variation paired with a random number from the encryption co-domain; replacing each edge in the graph of operations with a random choice from the pairing; encrypting the numerical data in the graph with numerical infinite lattice cryptography; and encrypting string data in the graph with string infinite lattice cryptography.

Example 12: The non-transitory computer storage of Example 11, wherein numerical infinite lattice cryptography comprises: generating a plaintext dataset, comprising the vectors for the substrings; selecting an order of a polynomial; selecting coefficients of the polynomial; projecting the plaintext dataset into a higher dimension plaintext space, using a first Riemannian metric; encrypting the polynomial with an encryption algorithm, generating an encrypted polynomial; and using the encrypted polynomial, as a second Riemannian metric of a ciphertext space, projecting the plaintext space into the ciphertext space.

Example 13: The non-transitory computer storage of some or all of Examples 11 and 12, wherein the first Riemannian metric comprises a first product of a first radial basis function and the polynomial, and wherein the second Riemannian metric comprises a second product of a second radial basis function and the encrypted polynomial.

Example 14: The non-transitory computer storage of some or all of Examples 11-13, wherein the first and second radial basis functions are the same.

Example 15: The non-transitory computer storage of some or all of Examples 11-14, wherein string infinite lattice cryptography comprises: receiving a string; extracting a set of substrings from the string; collating the set of substrings; generating a first set of random numbers; sorting the first set of random numbers; mapping the sorted random numbers to the collated substrings, such that each substring is mapped to a unique random number from the first set of random numbers; generating a second set of random numbers; generating a two-dimensional vector for each substring, the two-dimensions comprising an x-coordinate and a y-coordinate, wherein the x-coordinate for a substring comprises the random number from the first set mapped to the substring and the y-coordinate comprises a random number from the second set; and encrypting the vectors with a quantitative encryption algorithm.

Example 16: The non-transitory computer storage of some or all of Examples 11-15, wherein the functions further comprise linearizing the graph of operations by performing currying operations, wherein currying generates a linearized graph, having nodes, wherein each node comprises an operation with one variable.

Example 17: The non-transitory computer storage of some or all of Examples 11-16, wherein determining variations of each operation comprises: estimating an input state entropy of each operation in the graph of operations, based on an entropy parameter of each input; and generating a measure of surprisal, n_o, relative to the estimated input state entropy.

Example 18: The non-transitory computer storage of some or all of Examples 11-16, wherein each edge comprises a tuple (k_caller, k_callee), wherein k_caller is the index of an operation node and k_callee is an index of an input of the operation; and replacing comprises: selecting a random k_callee and a k_caller from the phase space of pairings.

Example 19: The non-transitory computer storage of some or all of Examples 11-18, wherein the replacing further comprises taking a modulo of a product of a hash of the input, k_callee and the k_caller.

Example 20: The non-transitory computer storage of some or all of Examples 11-19, wherein the encryption co-domain is the set of real numbers.

Some portions of the preceding detailed description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general-purpose computer selectively activated or reconfigured by a computer program stored in the computer. Such a computer program may be stored in a computer readable storage medium, such as, but not limited to, any type of disk including, hard drives, floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects.

An infinite lattice encryption can include performing two projections of the plaintext dataset. In a first projection, the plaintext dataset is projected into a higher dimension plaintext Riemannian space. In a second projection, an encrypted polynomial can be used as a Riemannian metric to project the Riemannian plaintext space into an encrypted ciphertext field. In this manner, an entire field can be encrypted, as opposed to individual, or bit-by-bit, encryption of the elements in the field. Within the encrypted field, various operators can be constructed. The encrypted field enables efficient homomorphic computations, executable on hardware accelerators. String data can be converted to high-entropy quantitative data, for example, a two-dimensional vector and encrypted using the described encryption algorithm. The conversion can preserve the collation order of the string if one dimension of the quantitative data is from a sorted set of random numbers.

What is claimed is:

1. A method comprising:
receiving a plaintext dataset;
selecting an order of a polynomial;
selecting coefficients of the polynomial;
projecting the plaintext dataset into a higher dimension plaintext space, using a first Riemannian metric;
encrypting the polynomial with an encryption algorithm, generating an encrypted polynomial; and
using the encrypted polynomial, as a second Riemannian metric of a ciphertext space, projecting the plaintext space into the ciphertext space.

2. The method of claim 1,
wherein the first Riemannian metric comprises a first product of a first radial basis function and the polynomial, and
wherein the second Riemannian metric comprises a second product of a second radial basis function and the encrypted polynomial.

3. The method of claim 2, wherein the first and second radial basis functions are the same.

4. The method of claim 1, wherein the encryption algorithm comprises an algorithm resistant to quantum computing attacks.

5. The method of claim 1, further comprising: generating one or more operators in the ciphertext space.

6. The method of claim 1, wherein the plaintext dataset, comprises a numerical or a scaler dataset.

7. The method of claim 1, wherein projecting the plaintext dataset into the plaintext space and projecting the plaintext space into the ciphertext space, preserve the relative order and magnitude of elements in the plaintext dataset in the plaintext space and the ciphertext space.

8. The method of claim 1, wherein the encryption algorithm comprises a lattice-based cryptography algorithm.

9. A non-transitory computer storage that stores executable program instructions that, when executed by one or more computing devices, configure the one or more computing devices to perform operations comprising:
receiving a plaintext dataset;
selecting an order of a polynomial;
selecting coefficients of the polynomial;
projecting the plaintext dataset into a higher dimension plaintext space, using a first Riemannian metric;
encrypting the polynomial with an encryption algorithm, generating an encrypted polynomial; and
using the encrypted polynomial, as a second Riemannian metric of a ciphertext space, projecting the plaintext space into the ciphertext space.

10. The non-transitory computer storage of claim 9,
wherein the first Riemannian metric comprises a first product of a first radial basis function and the polynomial, and
wherein the second Riemannian metric comprises a second product of a second radial basis function and the encrypted polynomial.

11. The non-transitory computer storage of claim 10, wherein the first and second radial basis functions are the same.

12. The non-transitory computer storage of claim 9, wherein the encryption algorithm comprises an algorithm resistant to quantum computing attacks.

13. The non-transitory computer storage of claim 9, wherein the operations further comprise: generating one or more operators in the ciphertext space.

14. The non-transitory computer storage of claim 9, wherein the plaintext dataset, comprises a numerical or a scaler dataset.

15. The non-transitory computer storage of claim 9, wherein projecting the plaintext dataset into the plaintext space and projecting the plaintext space into the ciphertext space, preserve the relative order and magnitude of elements in the plaintext dataset in the plaintext space and the ciphertext space.

16. The non-transitory computer storage of claim 9, wherein the encryption algorithm comprises a lattice-based cryptography algorithm.

17. A system comprising one or more processors, wherein the one or more processors are configured to perform operations comprising:
receiving a plaintext dataset;
selecting an order of a polynomial;
selecting coefficients of the polynomial;
projecting the plaintext dataset into a higher dimension plaintext space, using a first Riemannian metric;
encrypting the polynomial with an encryption algorithm, generating an encrypted polynomial; and
using the encrypted polynomial, as a second Riemannian metric of a ciphertext space, projecting the plaintext space into the ciphertext space.

18. The system of claim 17,
wherein the first Riemannian metric comprises a first product of a first radial basis function and the polynomial, and
wherein the second Riemannian metric comprises a second product of a second radial basis function and the encrypted polynomial.

19. The system of claim 18, wherein the first and second radial basis functions are the same.

20. The system of claim 17, wherein the encryption algorithm comprises an algorithm resistant to quantum computing attacks.
